(19) United States
(12) Patent Application Publication
(10) Pub. No.: US 2007/0021134 A1
(43) Pub. Date: Jan. 25, 2007

(54) Position reporting microphone

(76) Inventor: Henry Liou, Brea, CA (US)

Correspondence Address: Vieira & Associates;Attn: Erik M. Viera, P.O. Box 13593, La Jolla, CA, 92039, US

(21) Appl. No.: 11/364,568

(22) Filed: Feb. 27, 2006

Related U.S. Application Data
(63) Continuation-in-part of application No. 11/187,181, filed on Jul. 21, 2005.

(51) Int. Cl. H04B 7/00; H04Q 7/20

(52) U.S. Cl. 455/518

(57) ABSTRACT

A position reporting microphone, adapted for use in an existing communication system is disclosed. The position reporting microphone communicatively networks with the existing communication system channels to send and receive information such as for example audio, position, and/or identification information regarding the position reporting microphone.

### CROSS-REFERENCE TO RELATED APPLICATIONS

This application is a continuation-in-part application of co-pending U.S. divisional application Ser. No. 11/187,181, filed Jul. 21, 2005 to Liou, entitled GPS MICROPHONE FOR COMMUNICATION SYSTEM. This continuation-in-part application claims the benefit of prior nonprovisional application Ser. No. 11/187,181 under 35 U.S.C. 120. This application is related to issued U.S. Pat. No. 6,912,397 to Liou, entitled GPS MICROPHONE FOR COMMUNICATION SYSTEM. This application is also related to issued U.S. Pat. No. 6,941,147 to Liou, entitled GPS MICROPHONE FOR COMMUNICATION SYSTEM. This application is further related to co-pending non-provisional application Ser. No. 11/165,653, filed Jun. 24, 2005 to Liou, entitled SELF-POWERED POSITIONING AND MODEM SYSTEM FOR RADIO/AUDIO COMMUNICATION DEVICE; to co-pending divisional application Ser. No. 11/187,322, filed Jul. 21, 2005 to Liou, entitled GPS MICROPHONE FOR COMMUNICATION SYSTEM; to co-pending divisional application Ser. No. 10/989,195, filed Nov. 10, 2004 to Liou, entitled GPS MICROPHONE FOR COMMUNICATION SYSTEM; and, to co-pending divisional application Ser. No. 10/922,742, filed Aug. 19, 2004 to Liou, entitled GPS MICROPHONE FOR COMMUNICATION SYSTEM. All of the issued U.S. Patents and U.S. applications described above are hereby incorporated by reference herein, in their entirety, as if set forth in full.

### BACKGROUND

1. Field

The present disclosure generally relates to methods and apparatuses for networking in a communication system, and particularly for communicating position information of such apparatuses to the communication system.

2. Related Art

A Global Positioning System (GPS) is a space-based radio positioning network designed to provide users who are equipped with a suitable receiver with position, velocity, date, heading, altitude, quality of fix information, and time information. Developed by the United States Department of Defense, the space-based portion of GPS comprises a constellation of GPS satellites in non-geosynchronous 12 hour orbits around the Earth. A myriad of Global Positioning Satellite (“GPS”) capable devices are becoming more readily available in contemporary commercial markets, due to modern public access to GPS.

Personal GPS units allow hikers and mountaineers to navigate difficult and confusing terrain without fear of being lost. Maritime GPS units have been popular for many years now with both recreational and commercial boaters. LoJack® is yet another readily available consumer GPS product that has helped many vehicle owners recover their stolen vehicles. Nearly every high-end vehicle modernly comes equipped from the factory with a GPS navigational tracking system to guide a driver to a target destination.

Civil service providers, such as for example police, firefighters, and other such civil servants have not historically been provided as ready access to GPS networking equipment as their military counterparts. Although civil servants are not exposed to the same measure of danger as their military counterparts, police and firefighters in particular can easily find themselves in dangerous situations wherein a personal GPS network device would help ensure the safety of such an officer or firefighter.

A vast number of currently existing wireless two-way communication systems provide radio communications channels to approved users. Indeed, virtually every metropolitan area is laden with a plethora of wireless network infrastructure. A need exists to provide such currently existing communications systems with a personal GPS device, capable of “backfitting” to use the already existing communications channels to provide a cost effective GPS position tracking system.

Therefore, the present teachings provide such a personal GPS apparatus and system, which is robust, fast, and cost-effective and easily implemented in a currently existing two-way radio communications system.

### SUMMARY

In one embodiment, a system for communicating information in a wireless network between at least one user and a communication system is disclosed. The system generally comprises a position reporting microphone and a connector element. The position reporting microphone includes a speaker-microphone set, comprising a speaker element, operatively coupled to a microphone element, and a Push-to-Talk (“PTT”) circuit member, electrically connected to the microphone element, wherein the PTT circuit member is adapted to electrically activate the microphone element. The position reporting microphone further includes a position acquisition controller, operatively connected to the speaker-microphone set, comprising a position information receptor, adapted to receive positioning data from at least one external transponder system, and a signal converter, operatively coupled to the position information receptor, wherein the signal converter converts the positioning data received by the position information receptor into a quantity of positioning digital data. The position reporting microphone further includes a data manager element, electrically coupled to the position acquisition controller, wherein the data manager is adapted to parse the quantity of positioning digital data into a digital format suitable for use by a baseband audio signal processor. Also, the position reporting microphone includes a baseband audio signal processor element, electrically coupled to the data manager element, adapted to receive the suitably formatted quantity of positioning digital data, wherein the baseband audio signal processor element is adapted to generate a composite signal. A connector element is operatively connected to the position reporting microphone, wherein the connector element is adapted to provide at least one function via an interface member disposed thereon the connector element.

In another embodiment, an apparatus adapted to facilitate a plurality of electrical functionalities for a position reporting microphone is disclosed. The apparatus generally comprises a connector element and an interface member. The connector element is operatively coupled to the position reporting microphone. The interface member, operatively coupled to the connector element comprises an input port, adapted to input computer readable data to the position reporting microphone; an import port, adapted to import audio signals to the position reporting microphone; a charging port, adapted to charge a rechargeable power supply, wherein the rechargeable power supply is operatively associated with the position reporting microphone; an output port, adapted to output computer readable data from the position reporting microphone, and; an export port, adapted to export audio signals from the position reporting microphone.

In yet another embodiment, a system for providing a position reporting microphone means a plurality of electrical functionalities is disclosed. The system comprises connector means, operatively coupled to the position reporting microphone means; interface means, operatively coupled to the connector means, for interfacing the connector means to a plurality of inputs. The interface means comprises, charge means, operatively coupled to the interface means, for charging a rechargeable battery means, wherein the rechargeable battery means is operatively coupled to the position reporting microphone means; input means, operatively coupled to the interface means, for inputting computer readable data into the position reporting microphone means; import means, operatively coupled to the interface means, for importing audio signals into the position reporting microphone means; output means, operatively connected to the interface means, for outputting computer readable data from the position reporting microphone means, and; export means, operatively coupled to the interface means, for exporting audio signals from the position reporting microphone means.

### BRIEF DESCRIPTION OF THE DRAWINGS

Embodiments of the present disclosure will be more readily understood by reference to the following figures, in which like reference numbers and designations indicate like elements.

FIG. 1 is a block diagram of a position reporting microphone for a communication system, in accordance with the present teachings.

FIG. 2 is a flow diagram illustrating transmission signal pathways between a position reporting microphone and a communication system, in accordance with the present teachings.

FIG. 3 illustrates a block diagram of an alternate embodiment of the position reporting microphone, according to the present teachings.

### DETAILED DESCRIPTION

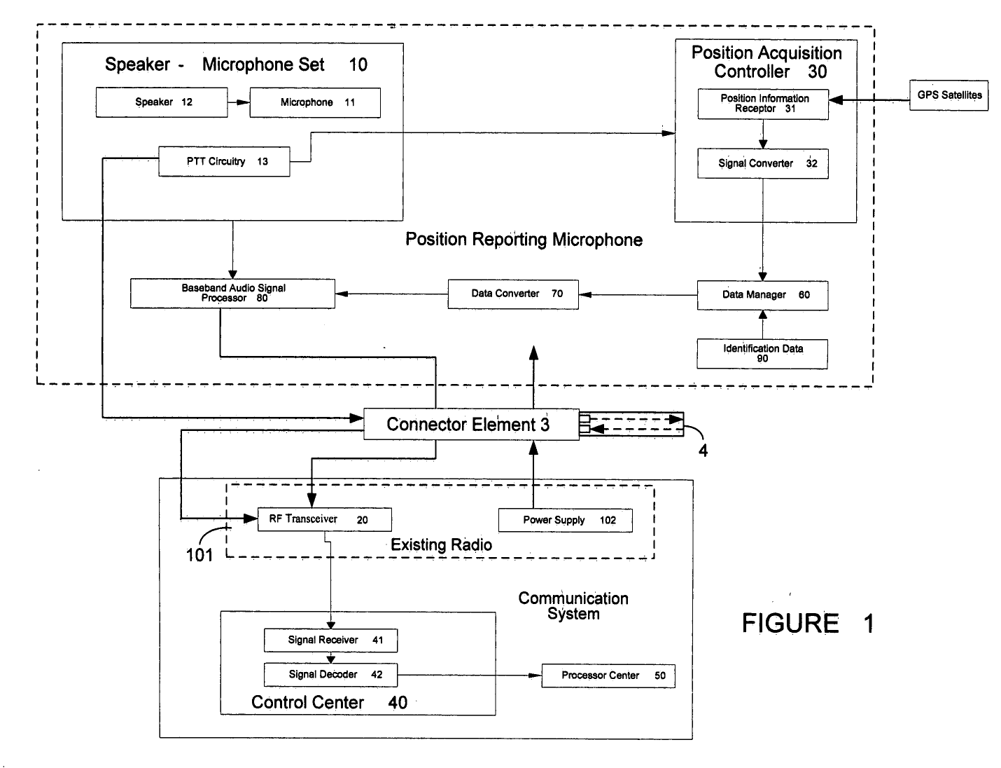

Referring to FIGS. 1-3 of the drawings, a position reporting microphone for networking with a communication system according to an illustrative exemplary embodiment of the present teachings is shown. In one exemplary embodiment, the position reporting microphone comprises a speaker-microphone set 10, a position acquisition controller 30 operatively connected with the speaker-microphone set 10, and a baseband audio signal processor 80, operatively connected to the position acquisition controller 30 and further connected to the speaker-microphone set 10. The position reporting microphone is operatively coupled to the communication system via an RF transceiver 20. In one embodiment, the position reporting microphone comprises a GPS microphone.

The speaker-microphone set 10 comprises a microphone 11, a speaker 12, and a PTT circuit 13, arranged in such a manner that when the PTT circuit 13 is triggered to activate the microphone 11, the microphone 11 is capable of receiving an audio signal from a user. In one embodiment of the present disclosure, the speaker-microphone set 10 activates an available channel in a communication system, such as for example a two-way radio system, wherein when the PTT circuit 13 is triggered, the microphone 11 is ready to receive an audio signal, and transmit the audio signal to the communication system through the RF transceiver 20.

The RF transceiver 20 of the position reporting microphone is a wireless communications device adapted to send and receive electromagnetic signals, wherein the RF transceiver 20 functions as a communication link between the position reporting microphone and the communication system. In one embodiment, the RF transceiver 20 unit is external to the position reporting microphone housing. The position reporting microphone provides a baseband output, which is fed into the RF transceiver 20, wherein the baseband output modulates an RF carrier waveform, in preparation for transmission, which is then broadcast to the communication system via the RF transceiver 20.

In one embodiment, a data manager 60 processes position and identification signals into a digital format. A data converter 70 converts digital data into baseband audio signals. In one embodiment, the data converter 70 comprises a data packet modem, such as for example a half-duplex data modem. A baseband audio signal processor 80 functions to generate a composite audio signal and position and/or identification signal. The baseband audio signal processor 80 generates a baseband audio/position/identification signal in at least one of three ways. In one embodiment, a position/identification signal is prepended to an audio signal. In another embodiment, the position/identification signal is appended to the audio signal. In yet another embodiment, the position/identification signal is parsed into discrete components and “spliced” or integrated into the audio signal at periodic time intervals, as will be readily appreciated by those of ordinary skill in the art.

The RF transceiver 20 can be automatically or manually tuned to communicate with another communication system by matching the same RF frequency. That is, more than one position reporting microphone can be set to use the same radio frequency by the manufacturer or security service company. Alternatively, the user is able to manually tune the RF transceiver 20 to communicatively network with another desirable communication system or automatically tune the RF transceiver 20 to search another communication system that is available within the same coverage area.

The position acquisition controller 30 comprises means 31 for receiving positioning data from an external position transponder system, such as an external GPS satellite. In one embodiment, the position acquisition controller 30 comprises a GPS controller. A signal converter 32 is arranged to convert the positioning data into a quantity of positioning digital data, which is then fed to the data manager 60. The data manager 60 functions to parse the quantity of positioning digital data into a format useable by other system components, such as for example, the baseband audio signal processor 80 and/or a data modem 5. In one embodiment, the well-known interface standard, NMEA-0183, is the digital data signal parsed by the data manager 60.

A means for receiving signals from free-space, according to one embodiment of the present teachings, is a position information receptor 31, such as a GPS antenna, adapted for wirelessly communicating with one or more GPS satellites so as to receive data therefrom. In one embodiment, the position acquisition controller 30 assumes NMEA-0183 message formats. Alternate GPS message formats, such as Trimble's proprietary TSIP format may be readily adapted for use, as will be appreciated by one of ordinary skill in the art. In addition to GPS protocols, other positioning systems, such as for example IMU, are also supported by the architecture of the present disclosure. The position information receptor 31 is interchangeable in the event other wireless messaging formats are desired to be used with the present disclosure.

The position reporting microphone further comprises a portable case 101, which houses the RF transceiver 20 and a power supply 102. An audio basedband output port is provided on the portable case 101 for transmitting a baseband audio output. Additionally, an RF port is provided on the portable case 101 for connection to a two-way radio. According to one embodiment of the present teachings, the power supply 102 of the GPS microphone comprises a rechargeable battery disposed in the portable case 101, wherein the rechargeable battery is electrically connected to the speaker-microphone set 10 to supply electrical power as needed.

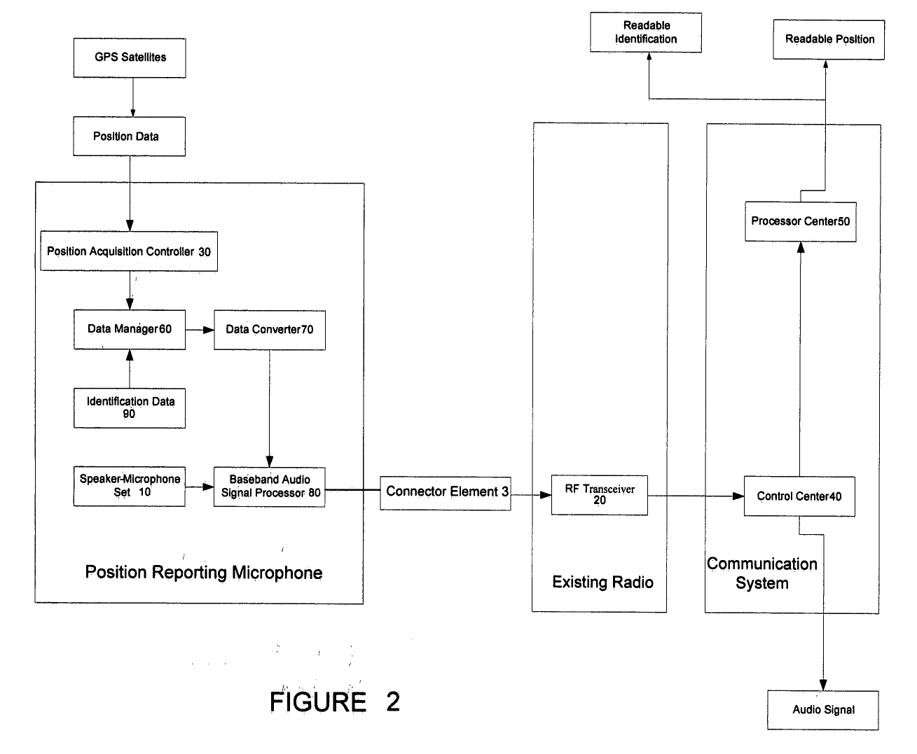

As shown in FIG. 2, one embodiment of the present disclosure provides a process of transmitting the positioning data from the position reporting microphone to the communication system, which comprises the STEPS of:

(1) communicatively networking an RF transceiver 20 to a communication system;

(2) activating, inter alia, a position acquisition controller 30, a data manager 60, a data converter 70, and a baseband audio signal processor 80 to encode the positioning and/or identification data onto a baseband signal, which is subsequently employed to modulate an RF carrier waveform, thus forming an encoded RF positioning signal;

(3) activating the RF transceiver 20 to transmit the encoded RF positioning signal to the communication system.

In STEP (1), the RF transceiver 20 is within a geographical area covered by a particular communication system, such that the position reporting microphone is in range of the particular communication system and capable of connecting to the communication system via the RF transceiver 20. Once a communication channel is established with the communication system, the RF transceiver 20 is capable of broadcasting a user's audio transmissions, and also of broadcasting an encoded RF positioning signal (containing, for example, position and/or identification data from the position reporting microphone).

In STEP (2), according to one exemplary embodiment of the present teachings, the position acquisition controller 30 is activated when the PTT circuit 13 of the speaker-microphone set 10 is triggered. In one embodiment, audio information input by a user to the speaker-microphone set 10 is combined with a quantity of position information (e.g., GPS location data), as described above (e.g., appended, prepended, spliced) to compose an encoded audio/position baseband signal. In one embodiment, identification information is also combined with the audio/position baseband signal to form an encoded audio/position/identification baseband signal. One purpose of the identification signal is to identify a specific position reporting microphone (e.g., GPS microphone), when a plurality of position reporting microphones are simultaneously accessing the same communications system. Combining of the audio, position, and identification signals is facilitated via a data manager 60, a data converter 70, and a baseband audio signal processor 80, as will be appreciated by those of ordinary skill in the art. Subsequently, the encoded audio/position baseband signal (alternatively the audio/position/identification baseband signal) is upconverted (i.e., mixed with a carrier waveform) to form an RF positioning signal.

In one embodiment, the position acquisition controller 30 (e.g., GPS controller) is adapted to be preset to be automatically activated for receiving positioning data for a period of time in STEP (2). In one exemplary embodiment, a user presets the position acquisition controller 30 to receive the positioning data every ten minutes. In this embodiment, when the RF positioning signal is encoded and upconverted, the RF transmitter 20 is ready to transmit the RF positioning signal to the communication system, irrespective of whether an audio signal has been received from the speaker-microphone set 10.

In yet another embodiment of the present teachings, the position acquisition controller 30 is adapted to be activated when a request is sent from the communication system. In this exemplary embodiment, a request signal is sent from the communication system to the position reporting microphone and is received by the RF transceiver 20. The request signal functions to activate the position acquisition controller 30 to receive positioning data. Such positioning data is subsequently prepared for transmission (as described above) and an RF positioning signal is thereafter transmitted to the communication system. When a user is unable to manually activate the position acquisition controller 30, the communication system is capable of remotely controlling the activation of the position acquisition controller 30 to track the location of the user. In one embodiment, the position acquisition controller 30 is manually activated by a user by activating a switch on the position acquisition controller 30, such as for example by pressing an activation button.

According to one embodiment, the communication system comprises, inter alia, a control center 40, and a processor center 50. The control center 40 comprises signal receiving means 41 and signal decoding means 42. The signal receiving means 41 receives an RF positioning signal broadcasted by the RF transceiver 20, and functions to downconvert the RF positioning signal to baseband frequencies. The downconverted RF positioning signal is then transferred to the signal decoding means 42. The signal decoding means 42 functions to decode and parse the RF positioning signal, into baseband audio and data (e.g., position and identification data).

The processor center 50 converts the position and/or identification data into computer readable data, in order to associate a particular position reporting microphone within the coverage area of the communication system with a specific identification code and specific positioning data (e.g., GPS location data).

In one exemplary embodiment of the present teachings, shown in FIG. 1, a police officer carries a position reporting microphone on his person, and a communication system is installed in the police squad car. When an officer moves away from the squad car, a communication network is established between the RF transceiver 20 and the squad car communication system. Hence, another police officer, remaining inside the squad car will readily be able to track the other police officer moving away from the squad car.

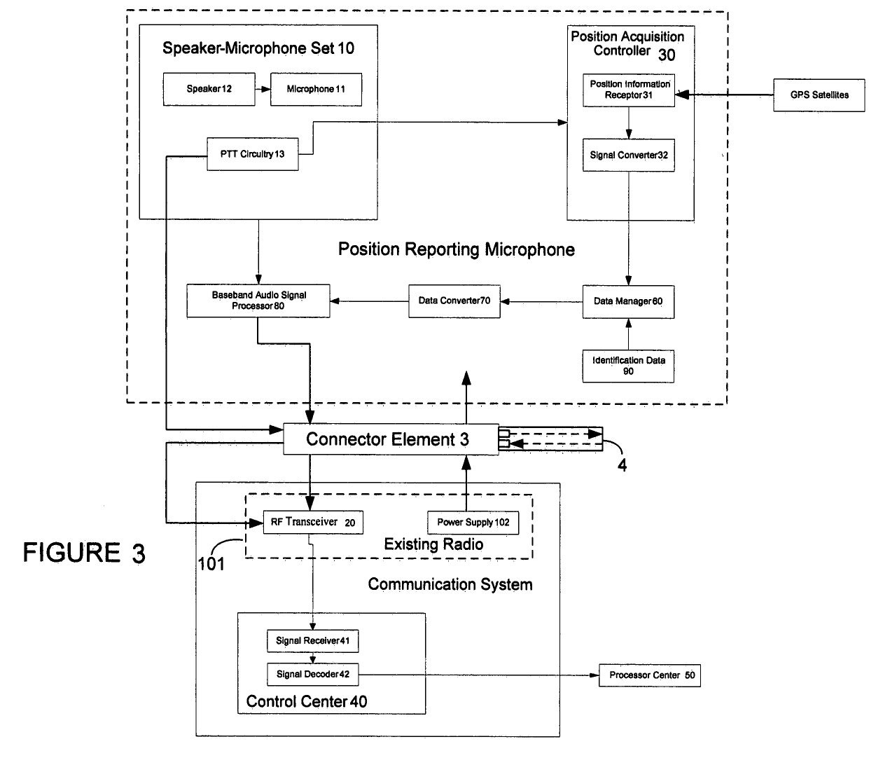

In yet another embodiment, shown in FIG. 3, a control center 40 is installed inside a police squad car, and the processor center 50 is located at a police station. The police officer carrying the position reporting microphone is able to send and receive audio tones to and from the police station via normal two-way radio means available on the position reporting microphone, and approximately simultaneously, position data for that police officer is transmitted by the position reporting microphone to the processor center 50, via the control center 40 as described above.

In one illustrative exemplary embodiment, a connector element 3 is disposed on the position reporting microphone of the present disclosure. The connector element 3 provides one or more of the following functionalities:
1.) charging the position reporting microphone;
2.) charging the radio battery;
3.) inputting data to the position reporting microphone;
4.) outputting data from the position reporting microphone (e.g., for connecting to a monitor, pda, computer, etc . . . );
5.) importing audio;
6.) exporting audio;
7.) programming the position reporting microphone, and;
8.) programming the radio.

In one exemplary application, police officers in a law enforcement field operation will find such a connector element 3 useful. Operative connection to the connector element 3 is accomplished via an interface member 4, wherein the interface member 4 is adapted to operatively couple the connector element 3 (and therefore the position reporting microphone) to external devices. As described above, a police officer wearing a position reporting microphone on his person will have his location periodically reported to either a police squad car, or to a police station, depending on the location of the processor center 50. In a situation wherein a plurality of police officers are performing law enforcement activities in an area covered by a local communication system, and each officer is wearing a position reporting microphone on his person, the precise location of each officer in the area will be reported back to the processor center 50 periodically. If one of the officers in the field operation desires to know the location of other officers in the field (e.g., field operations team-leader), such location information may be transmitted to that particular officer's position reporting microphone. Once the officer has received such a transmission, the officer may connect his position reporting microphone, via the interface member 4, into a device, such as for example, a monitor, personal digital assistant (“PDA”), laptop computer, or literally any other device capable of rendering such information visually. In one embodiment, the officer connects his PDA (or other device) into the interface member 4, to receive information output from his position reporting microphone. Similarly, a processor center 50 (e.g., police dispatch center) can send “all units location” data to all position reporting microphones in the communication system coverage area. Each police officer could then connect his position reporting microphone to a computer, monitor, PDA, or other such device for viewing all other officers' locations in the relevant area. A myriad of similar applications are envisioned using the present teachings, such as for example, military field applications and firefighters battling forest fires or structure fires.

In one variation of the aforementioned embodiment, the interface member 4 of the connector element 3 is adapted to receive a charger input for charging a battery operatively associated with the position reporting microphone. Exemplary charger inputs include a wall charger or a car charger. In another variation, the interface member 4 is adapted to output an audio signal from the position reporting microphone for input into an external speaker to amplify a speaker's audio transmission.

In yet another alternate embodiment, the connector element 3 is useful for inputting programming data directly from a computer by connecting the computer to the connector element 3 via the interface member 4. Similarly, data can be extracted from the position reporting microphone to a computer, monitor, or Navigator (i.e., mapping program, showing directions or additional target locations of relevance). In one embodiment, if historical location information has been stored in a particular position reporting microphone memory, such information is readily extracted via the interface member 4.

In one embodiment, the connector element 3 is disposed within the position reporting microphone housing, and is accessible via the interface member 4. In yet another embodiment, the connector element 3 is disposed external to the position reporting microphone, and is readily accessible via the interface member 4.

Those skilled in the wireless communications art will appreciate that the present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The communication systems described herein above may operate in a networked environment using logical connections to one or more remote computers. These logical connections can be achieved using a communication device that is coupled to or be a part of the computer; the present teachings are not limited to a particular type of communications device. The remote computer may be another computer, a server, a router, a network PC, a client, a peer device or other common network node, and typically includes many or all of the elements described above relative to the computer. The logical connections include a local-area network (LAN) and a wide-area network (WAN). Such networking environments are commonplace in office networks, enterprise-wide computer networks, intranets and the Internet, which are all types of networks.

When used in a LAN-networking environment, the computer is connected to the local network through a network interface or adapter, which is one type of communications device. When used in a WAN-networking environment, the computer typically includes a modem, a type of communications device, or any other type of communications device for establishing communications over the wide area network, such as the Internet.

The foregoing description illustrates exemplary implementations, and novel features, of aspects of an apparatus for broadcasting positioning information. Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1. A system for communicating information in a wireless network between at least one user and a communication system, comprising:
a) a position reporting microphone, comprising:
i) a speaker-microphone set, comprising:
(A) a speaker element operatively coupled to a microphone element;
(B) a PTT circuit member, electrically connected to the microphone element, wherein the PTT circuit member is adapted to electrically activate the microphone element;
ii) a position acquisition controller, operatively connected to the speaker-microphone set, comprising:
(A) a position information receptor, adapted to receive positioning data from at least one external transponder system;
(B) a signal converter, operatively coupled to the position information receptor, wherein the signal converter converts the positioning data received by the position information receptor into a quantity of positioning digital data;
iii) a data manager element electrically coupled to the position acquisition controller, wherein the data manager is adapted to parse the quantity of positioning digital data into a digital format suitable for use by a baseband audio signal processor;
iv) a baseband audio signal processor element, electrically coupled to the data manager element, adapted to receive the suitably formatted quantity of positioning digital data, wherein the baseband audio signal processor element is adapted to generate a composite signal, and;
b) a connector element, operatively connected to the position reporting microphone, wherein the connector element is adapted to provide at least one function via an interface member disposed thereon the connector element.

2. The system of claim 1, wherein the data manager is further operatively coupled to an identification data element, wherein the identification data element is adapted to provide specific identification data for a particular position reporting microphone.

3. The system of claim 2, wherein the data manager is operatively coupled to a data converter element, wherein the data converter element is adapted to convert digital data into baseband audio signals.

4. The system of claim 3, wherein the composite signal generated by the baseband audio signal processor element comprises audio and position data.

5. The system of claim 4, wherein the composite signal generated by the baseband audio signal processor element further comprises an identification signal.

6. The system of claim 5, wherein the position reporting microphone further comprises a rechargeable power supply operatively associated therewith.

7. The system of claim 6, wherein the at least one function provided by the connector element comprises electrically charging the rechargeable power supply via the interface member.

8. The system of claim 1, wherein the interface member of the connector element is adapted to input data to the position reporting microphone.

9. The system of claim 8, wherein the interface member of the connector element is further adapted to output data from the position reporting microphone.

10. The system of claim 9, wherein the interface member of the connector element is further adapted to import audio signals to the position reporting microphone.

11. The system of claim 10, wherein the interface member of the connector element is further adapted to export audio signals from the position reporting microphone.

12. The system of claim 11, wherein the interface member of the connector element is further adapted to facilitate programming of the position reporting microphone.

13. The system of claim 1, wherein the interface member of the connector element is adapted to facilitate programming of the position reporting microphone.

14. An apparatus adapted to facilitate a plurality of electrical functionalities for a position reporting microphone, comprising:
a) a connector element, operatively coupled to the position reporting microphone, and;
b) an interface member, operatively coupled to the connector element, whereby the interface member comprises;
i) an input port, adapted to input computer readable data to the position reporting microphone;
ii) an import port, adapted to import audio signals to the position reporting microphone;
iii) a charging port, adapted to charge a rechargeable power supply, wherein the rechargeable power supply is operatively associated with the position reporting microphone;
iv) an output port, adapted to output computer readable data from the position reporting microphone, and;
v) an export port, adapted to export audio signals from the position reporting microphone.

15. The apparatus of claim 14, wherein the input port is further adapted to receive programming data into the position reporting microphone.

16. The apparatus of claim 15, wherein the output port is further adapted to output computer readable data in a video format.

17. The apparatus of claim 16, wherein the output port is further adapted to output computer readable data suitable for use by a navigational software program.

18. A system for providing a position reporting microphone means a plurality of electrical functionalities, comprising:
a) connector means, operatively coupled to the position reporting microphone means;
b) interface means, operatively coupled to the connector means, for interfacing the connector means to a plurality of inputs, comprising:
i) charge means, operatively coupled to the interface means, for charging a rechargeable battery means, wherein the rechargeable battery means is operatively coupled to the position reporting microphone means;
ii) input means, operatively coupled to the interface means, for inputting computer readable data into the position reporting microphone means;
iii) import means, operatively coupled to the interface means, for importing audio signals into the position reporting microphone means;
iv) output means, operatively connected to the interface means, for outputting computer readable data from the position reporting microphone means, and;
v) export means, operatively coupled to the interface means, for exporting audio signals from the position reporting microphone means.

19. The system of claim 18, further comprising viewing means, operatively coupled to the output means, for viewing the computer readable data in a visual format.

20. The system of claim 19, wherein the interface means is further adapted to couple to a navigational computing system.
